(19) United States
(12) Patent Application Publication
(10) Pub. No.: US 2012/0031957 A1
(43) Pub. Date: Feb. 9, 2012

(54) VACUUM INSULATION PANEL

(75) Inventor: Mark Whitaker, Barrington, IL (US)

(73) Assignee: PackagingPrice.com, Inc., Barrington, IL (US)

(21) Appl. No.: 12/852,753

(22) Filed: Aug. 9, 2010

(51) Int. Cl. B65D 5/42; B65D 81/38; B32B 3/12

(52) U.S. Cl. 229/103.11; 428/116; 428/117; 428/118; 220/592.27

(57) ABSTRACT

A vacuum insulation panel that includes a paper core made of at least one panel consisting of first and second facing sheets, made of paper, that sandwich a paper honeycomb structure. The honeycomb structure preferably includes a plurality of cells that extend from the first facing sheet to the second facing sheet. The panel also includes an outer shell that surrounds the core, wherein the outer shell is made of a material of low gas permeability and is sealed to form a substantially airtight container around the core. In preferred embodiments, an interior of said outer shell has been evacuated to a pressure of between approximately 1-10 Torr, resulting in an insulating panel that has an R-value of approximately 3.

The present invention relates generally to a vacuum insulation panel and to a packaging system including such a panel, and it relates more particularly to such a panel that includes a core with a plurality of evacuated cells that is made of paper, or other inexpensive material, and to a packaging system including such a panel.

### BACKGROUND OF THE INVENTION

Different types of insulating panels for different uses and environments are known. Many of the known types of insulating panels can be relatively expensive, depending upon the materials used and the manufacturing processes required to fabricate the panels. For example, there are known panels that each include a core made of a specific insulating material, such as perlite, mineral powder, mineral fiber, fiberglass or silica. While most of these materials are not very expensive in their raw form, they require considerable handling and pre-processing, which can greatly increase the cost of the end product.

A number of improved core materials have recently been developed. These core materials fall into two broad categories: (i) open-cell foam and (ii) carbon/silica aerogels. While these types of materials generally require less pre-processing than earlier materials, they are generally much more expensive initially. Accordingly, panels made from such improved materials are also relatively expensive.

Thus, although such insulating panels provide excellent insulating properties, they are too costly for many uses. An additional drawback of such panels is that at the end of their useful life, they are simply discarded with other trash, and therefore will most likely end up in landfills or will be incinerated.

Accordingly, one of the objectives of the present inventor is to provide an insulating panel that is relatively inexpensive. Another more particular objective is to provide at least some embodiments of insulating panels in which at least the core materials are capable of being recycled.

### BRIEF SUMMARY OF THE INVENTION

Embodiments of the present invention relate to a low cost vacuum insulation panel in which the core is made of light-weight, inexpensive paper. The use of such paper makes the present panel more environmentally conscious than previous devices because the core can be part of a closed loop system in which the core is fabricated from recycled paper, and then, at the end of the useful life of the panel, at least the core (and preferably other components of the panel) can be recycled into new products, such as new core materials. Such a product is more eco-friendly than other insulation products, such as foamed expanded polystyrene or closed-cell extruded polystyrene foam (Styrofoam®), both of which can be relatively difficult to recycle in most localities, and which are both oil-based products to begin with. Further, the present vacuum insulation panel can provide an R-value of approximately 3 (per inch of thickness), which is similar to that of expanded polystyrene foam, which typically has an R value of approximately 4 (per inch of thickness).

More specifically, embodiments of the present invention provide a vacuum insulation panel that includes a paper core made of at least one panel consisting of first and second facing sheets, made of paper, that sandwich a paper honeycomb structure. The honeycomb structure preferably includes a plurality of cells that extend from the first facing sheet to the second facing sheet. The panel also includes an outer shell that surrounds the core, wherein the outer shell is made of a material of low gas permeability and is sealed to form a substantially airtight container around the core. An interior of said outer shell has been evacuated to a pressure of between approximately 1-10 Torr, resulting in an insulating panel that has an R-value of approximately 3.

### BRIEF DESCRIPTION OF THE SEVERAL VIEWS OF THE DRAWINGS

Preferred embodiments of the present invention are described herein with reference to the drawings wherein:

FIG. 1 is a top perspective view of one example of a first embodiment of a vacuum insulation panel of the present invention;

FIG. 2 is a schematic of a perspective view of one example of a core of the FIG. 1 embodiment of the present vacuum insulation panel, shown without the outer shell;

FIG. 3 is a schematic cross-sectional view of the vacuum insulation panel of FIG. 1;

FIG. 4 is a schematic top view of the vacuum insulation panel of FIG. 1;

FIG. 5 is a schematic cross-sectional view of first modification of the vacuum insulation panel of FIG. 1;

FIG. 6 is a schematic cross-sectional view of a second modification of the vacuum insulation panel of FIG. 1;

FIG. 7 is a schematic cross-sectional view of a third modification of the vacuum insulation panel of FIG. 1;

FIG. 8 is a perspective view of an example of an insulating packaging system of the present invention;

FIG. 9 is a side view of a portion of a second example of an insulating packaging system of the present invention;

FIG. 10 is a top view of the structure of FIG. 9, shown configured into a ring-shape; and

FIG. 11 is a side view of all three main components of the insulating packaging system of the second example, including the ring-shaped structure 70 shown in FIG. 10.

### DETAILED DESCRIPTION OF THE INVENTION

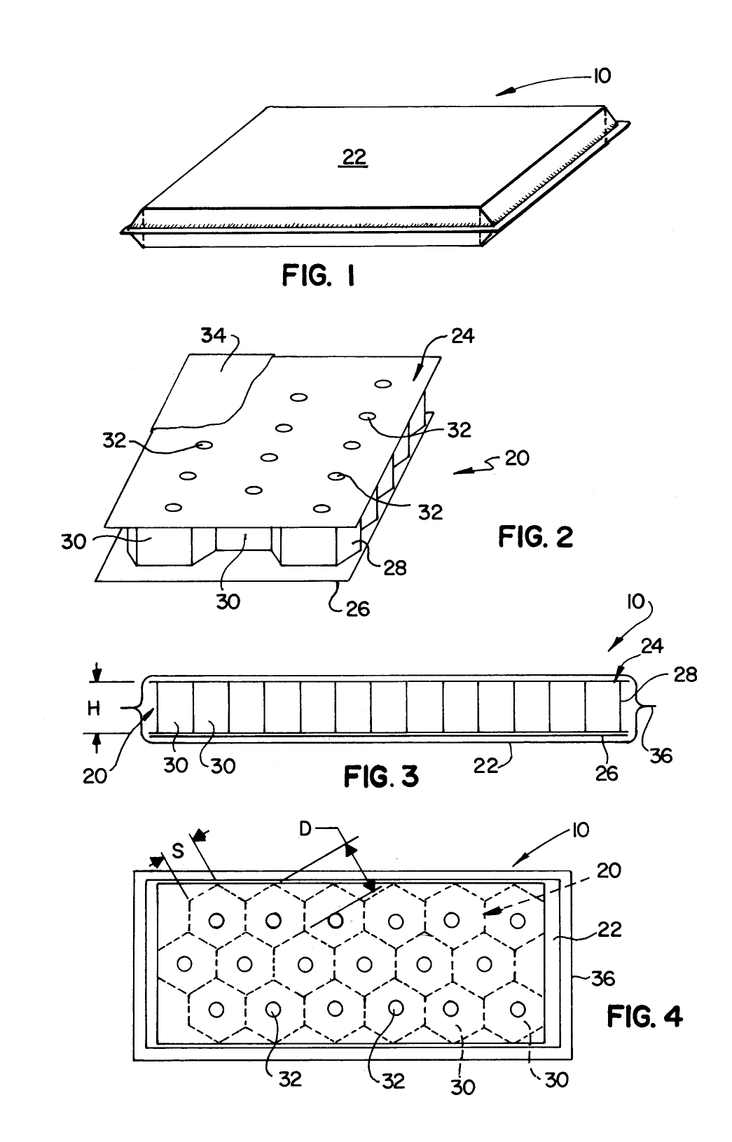

Turning now to the figures, various embodiments of the present invention will be described. In particular, FIG. 1 is a top perspective view of one embodiment of a vacuum insulation panel 10 of the present invention; FIG. 2 is a schematic perspective view of the core 20 of the panel 10 of FIG. 1, shown without an outer shell; FIG. 3 is a schematic cross-sectional view of the panel 10 of FIG. 1; and FIG. 4 is a schematic top view of the panel 10 of FIG. 1.

Briefly, embodiments of the present vacuum insulation panel include two main parts: a core and an outer shell. FIG. 1 shows one example of an embodiment of such a panel 10 in which a vacuum core is encased within an outer shell 22. As described in detail below, the core 20 (FIG. 2) includes a plurality of cells that have been evacuated through a vacuum process, and the outer shell 22 is provided to maintain the vacuum situation within the core. One of the purposes of the core 20 is to prevent the outer shell 22 from collapsing onto itself while the vacuum is being applied.

As can be seen in FIG. 2, the core 20 consists of a panel consisting of a first facing sheet 24 and a second facing sheet 26. Between the sheets 24 and 26, there is provided a honeycomb structure 28 that includes a plurality of open cells 30. Preferably, the cells 30 each extend all the way from the first facing sheet 24 to the second facing sheet 26, as shown in both FIGS. 2 and 3.

In the preferred embodiments of the present invention, the first facing sheet 24, the second facing sheet 26 and the honeycomb structure 28 are all made of paper. More specifically, the structure may be made from a type of paper commonly referred to as kraft corrugated linerboard, which consists of a single faced honeycomb structure, to which a second facing sheet, of kraft linerboard, is added. Making these components of paper has many benefits, such as paper is a relatively low cost material, paper is widely available, and paper is readily formable into the desired configuration. Further, once a paper core panel is made, it is easily cut into the desired size and shape. Additionally, the configuration of the core panel makes it surprisingly rigid, especially considering its light weight and the use of paper material. For example, the pressure rating (in pounds per square inch, “psi”) of a typical honeycomb structure is between 11 and 60 psi. Honeycomb structures with psi ratings of approximately 20 psi have been found to be sufficiently rigid for use in most of the embodiments described below

In addition to the other benefits of using paper, there are also environmental benefits obtained from using paper for the facing sheets and the honeycomb structure. For example, fabricating the paper sheets and processing them into the desired configuration can be done while: (1) using only water-based adhesives; (2) using paper stock made with up to 40% post consumer fiber; (3) using a manufacturing process that emits zero volatile organic compounds (VOCs); and (4) using a manufacturing process that is chlorofluorocarbon-free. Additionally, when the core 20 is made completely of paper products, it can easily be recycled at the end of its useful life, instead of adding additional waste to overburdened landfills. Further, environmental benefits can also be achieved by fabricating the facing sheets and the honeycomb structure from recycled paper, such as through the use of up to 40% post consumer fiber, as mentioned above.

As stated above, the core 20 undergoes a vacuum process, which increases its insulating properties. Prior to performing the vacuum process, the core 20 is preferably sent through a heating mechanism to dry the core. For example, the core 20 may be conveyed through an oven at approximately 350° F. for a period of about 15 minutes to dry the core, which provides a slight weight reduction on the order of approximately 10-15%. Drying the core also serves to reduce the amount of time required during the vacuum process to obtain the desired vacuum level.

In order to facilitate the evacuation process of removing the air within the core 20, each cell 30 preferably includes an evacuation aperture 32 formed in the first facing sheet 24, as shown in FIG. 2. As can be seen in FIG. 2, each evacuation aperture 32 is in fluid communication with its associated cell 30. Although evacuation apertures 32 do not increase the insulating properties, they are useful to help reduce the cycle time required to obtain the desired vacuum level during the manufacturing process. Evacuation apertures of ⅛ inch diameter have proven sufficient for this purpose, and thus it is contemplated that apertures of diameters within the range of 0.05 inch to 0.1875 inch would also perform the desired function.

Of course, the evacuation apertures 32 could be formed in the second facing sheet 26 instead of in the first facing sheet 24. Alternatively, the evacuation apertures could be formed in both the first and second facing sheets. Additionally, it is contemplated that each cell 30 could include more than one evacuation aperture.

In the embodiment shown in FIGS. 1-4, each cell 30 is of a hexagonal shape, as can be seen the top view of FIG. 4. However, other polygonal shapes (such as triangles, quadrilaterals, pentagons, heptagons, octagons, etc.) are also contemplated as being within the scope of the invention. It is also contemplated that either regular or irregular polygons could be used as the shape for the cells. Further, instead of being formed of polygons, the cells could also be formed with curved boundaries. In addition, it is also contemplated that the different cells within a single honeycomb structure 28 could be formed of multiple different shapes, instead of all being the same shape as shown in the embodiment of FIGS. 1-4.

In the example of the preferred embodiment shown in FIGS. 1-4, each of the cells 30, which are each a regular hexagon in shape, has a height H (FIG. 3) of approximately ½ of an inch tall, and the length of each side S (FIG. 4) is approximately ½ inch. Thus, in this embodiment, the area of each cell (at either of facing sheets) is approximately 0.65 square inches (in²), which was arrived at by using the formula: area=((3×√3)×S²)/2, and the volume of each cell is approximately 0.325 cubic inches (in³). Of course, other heights and distances are also contemplated as being within the scope of the invention.

Within the industry, such hexagonal structures 28 are typically designated by a cell “diameter” size. Although not technically a diameter (because the hexagon is not a circle), the “diameter” of a cell 30 is the distance represented by the letter “D,” as shown in FIG. 4. In other words, the cell “diameter” D is the distance between a pair of opposing sides. Hexagonal structures are available in a variety of different cell diameters, such as ¼ inch, ½ inch, 0.6 inch, ¾ inch, etc.

With regard to the size of the cells, the present inventor has unexpectedly found that cells of larger area and volume generally provide the evacuated core with better insulating properties than when using smaller cells. Such a finding goes against the conventional wisdom of those of ordinary skill in the art, who would have expected larger cell sizes to result in reduced insulating properties because, for example, larger cell sizes would be considered as resulting in more heat transfer due to convection. For example, the cell height H is preferably within a range of 0.25 inches and 1.5 inches, and more preferably within the range of 0.4 inches to 1.0 inches; and the cell side length S is preferably within the range of 0.25 inches to 1 inch, and more preferably within the range of 0.4 to 0.75 inches. Thus, the area of each cell is preferably within the range of approximately 0.16 to 2.6 in², and more preferably within the range of approximately 0.4 to 1.5 in²; and the volume of each cell is preferably within the range of approximately 0.04 and 3.89 in³, and more preferably within the range of 0.166 and 1.46 in³. The range of 0.325 to 2.6 cubic inches for the volume of each cell is also believed to be satisfactory. The suggested values provided for the area ranges and volume ranges are believed to be useful, regardless of the shape of the cells.

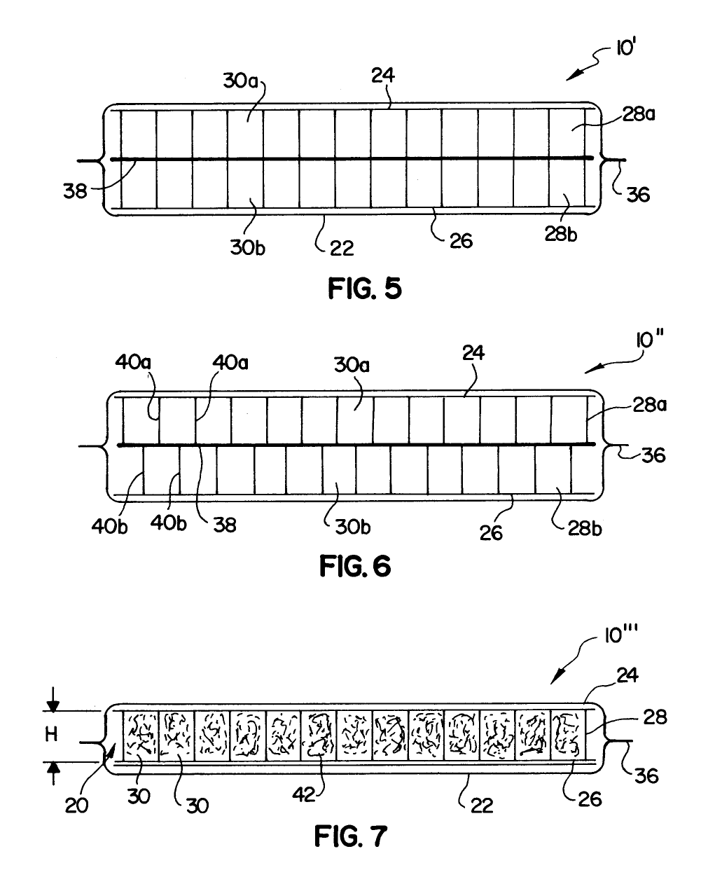

For example, tests on two samples, both having cell height H of ½ inch and which each included a double-height stacked core (such as shown in FIG. 5), showed that for a cell diameter of 0.6 inch the sample achieved an R value of 2.45, while the sample with a cell diameter of 0.75 inch achieved an R value of 3.0.

In the preferred embodiment of FIGS. 1-4, each of the cells 30 is of approximately the same size. However, it is also contemplated cells of two, or more, different sizes may be combined within the same honeycomb structure (with either all cells being of the same shape, or with the cells being made of two or more different shapes).

Optionally, it is believed that the ability of the core 20 to reflect radiant heat may be improved by adding a reflective layer to either, or both, of the facing sheets 24, 26. FIG. 2 shows, in partial cut-away, a reflective layer 34 positioned upon facing sheet 24. The optional reflective layer 34 may be made of any desired reflective material such as a thin sheet of aluminum, or other polished or foiled metal, such as copper, gold tin or steel. The reflective layer 34 could also be made of a metalized film, such as those produced by sputter coating an extremely thin layer of metal upon the surface of a film of plastic or other material. The reflective layer 34 may be adhered to the facing sheet in any desired manner, such as with an adhesive, or it may simply be placed on the facing sheet without using an adhesive. It should be noted that if an adhesive is used, only one or more thin stripes of adhesive, or small islands of adhesive, are necessary, as all that is required of the adhesive is to maintain the reflective layer in position, and a hermetic seal is not necessary. Also, it is not necessary to provide evacuation apertures in the reflective layer because there will be airflow between the reflective layer and the associated facing sheet. However, if desired, evacuation apertures may be provided in the reflective layer in positions that correspond to any evacuation apertures located on the associated facing sheet.

Turning now to the second main part of the present insulating panel, the outer shell 22, details of examples of the outer shell will be discussed next. As can be seen in FIG. 3, the outer shell 22 surrounds the core 20. In order to maintain the evacuated state of the core 20, the outer shell is preferably made of a material of low gas permeability, such as a plastic film of Ethylene Vinyl Alcohol (EVOH) or polyvinyllidene chloride (PVDC). The outer shell could also be made of a ceramic barrier film, such as escal; of a barrier grade nylon; of an aluminum foil; of a metalized film; or of another type of barrier similar material. Preferably, such films are constructed of a multi-layer structure that includes a barrier material, such as one of those mentioned above, that is bonded to the other layers that provide other functions, such as sealing or the ability to be printed upon.

The outer shell 22 may be fabricated in a variety of different ways. For example, the outer shell 22 may be made from a bag that has its open end sealed after the core 20 has been inserted within the bag, or the shell may be made of two sheets sandwiching the core, where the sheets are sealed around their entire periphery. Additionally, features of these two configurations may be combined by using a bag and sealing the entire periphery so that the bag tightly conforms to the shape of the core. FIGS. 1, 3 and 4 show the results of such a combination in which the outer shell 22 consists of a bag whose entire periphery 36 has been sealed in an airtight manner, thus creating a substantially airtight container around the core 20. Heat sealing is one example of a simple process that may be used to create the periphery seal 36. Of course, other methods of sealing the outer shell are also contemplated.

Optionally, any known “getter” material could be deposited within the outer shell 22 in order to help absorb any remaining gasses after the vacuum evacuation. Examples of such getter materials include activated alumina, activated charcoal, silica gels and molecular sieves.

As mentioned above, preferred embodiments of the present vacuum insulation panel have an R value, per inch of thickness, of approximately 3, which has been realized for an embodiment made of two ½ inch thick layers of core material of ¾ inch cell diameter, including two aluminum foil reflective layers (one on each other surface). Other embodiments are expected to have R values, per inch of thickness, within the range of 2-4 R.

One example of a method of fabricating an insulation panel of the present invention will be described next. Preferably, the core 20 is created before it is sealed within the outer shell 22. A core 20 consisting of two facing sheets 24, 26 adhered to a honeycomb structure 28 could be purchased in a pre-assembled condition from a paperboard manufacturer, or a honeycomb structure 28 with a single facing sheet could also be purchased, and the second facing sheet could then be added

Alternatively, the core 20 can be created by adhering, such as with an adhesive, the first facing sheet 24 and the second facing sheet 26 on opposite sides of a honeycomb structure 28. Paper facing sheets and paper honeycomb structures are readily available from the packing industry, but these sheets could also be custom made using any desired fabrication process.

If the evacuation apertures 32 are to be utilized, they can be punched, cut or otherwise formed into the appropriate facing sheet(s) 24, 26 at the appropriate locations after the facing sheets have been mated with the honeycomb structure 28. In the alternative, the evacuation apertures 32 may be provided in the facing sheet(s) 24, 26 before mating the facing sheets with the honeycomb structure 28, or the apertures could be formed at the point in time after one facing sheet is mated with the honeycomb structure, but before the other facing sheet has been mated with the honeycomb structure.

Next, if the optional reflective layer(s) 34 is/are to be utilized, stripes or islands of adhesive can be applied to the appropriate facing sheet(s), if the use of an adhesive is desired, and each reflective layer is then attached to the appropriate facing sheet or sheets. As mentioned above, it is also contemplated that the reflective layer(s) could merely be placed upon the facing sheet(s), without using adhesive. If desired, apertures may be added to the reflective layer(s) at positions corresponding to the evacuation apertures in the relevant facing layer. In the alternative, apertures in both the reflective layer 34 and the associated facing sheet (24, 26) may be formed simultaneously by punching, cutting or otherwise forming the evacuation apertures after the reflective layer has been attached to the facing sheet.

After the core 20 has been created, it can be inserted into a bag that is made of a material with low permeability to gas, which bag forms the outer shell 22. At this point, the assembly can be placed in a vacuum chamber to perform the evacuation process. Alternative vacuum processing methods are also contemplated, such as by using a device in which one or more tubes are inserted into the bag comprising the outer shell 22, whereby such tubes remove the air from the bag, and then sealing the bag to maintain the vacuum condition.

Preferably, the vacuum process is performed until the pressure within the outer shell 22 is less than 10 Torr. More preferably, the pressure is within the range of between approximately 1-10 Torr, and most preferably a range of between approximately 1-5 Torr provides a good balance of high insulation properties with efficient evacuation.

After the vacuum processing, the outer shell 22 should be hermetically sealed to create an airtight container around the core 20. As mentioned above, the seal may be realized by any desired method, such as by heat sealing the perimeter 36.

Although one method of fabricating insulating panels has been discussed, other method may be used, if desired. For example, a layering method is contemplated in which the core and outer shell are made during a single process by stacking the various layers upon each other. Briefly, such a method involves starting with a bottom layer of the outer shell, then stacking the optional reflective layer thereon, the first facing sheet, then the honeycomb structure, then the second facing sheet, then another optional reflective sheet, and finally stacking the top layer of the outer shell. The process continues to the evacuation step and the heat sealing step described above. As an alternative, the core of the insulating panel could also be made by starting with the honeycomb structure, and then affixing the facing sheets and reflective sheets on the opposite faces of the honeycomb structure.

Regardless of which method of fabrication is utilized, after the manufacturing process is complete, the preferred embodiments of the present vacuum insulation panel do not require the use of a vacuum pump to maintain the desired level of vacuum within the core. Accordingly, the present vacuum insulation panel can be used for a variety of different purposes, such as to provide insulation to boxes being transported by truck, train, boat, airplane, etc.

Turning now to FIGS. 5-7, modified embodiments of the present insulating panel are shown and will be described. FIG. 5 is a cross-sectional view of a first modification, which will be designated as panel 10′, FIG. 6 is a cross-sectional view of a second modification, which will be designated as panel 10″, and FIG. 7 is a cross-sectional view of a third modification, which will be designated as panel 10′″.

The embodiment shown in FIG. 5 is essentially the same as the embodiment of FIGS. 1-4, except that instead of having only a single honeycomb structure 28, this embodiment includes two honeycomb structures, 28A and 28B, which are stacked upon each other. The use of two stacked honeycomb structures greatly enhances the insulating properties of the insulating panel. Moreover, honeycomb structures of high thicknesses, such as of one inch or greater, do not withstand the vacuum pressure as well as those of lower thicknesses. Thus, it is generally better to use two, or more, panels of thinner material than a single panel of thicker material, if a total thickness for all panels of one inch or greater is desired.

As shown in FIG. 5, this embodiment also preferably includes an intermediate facing sheet 38 between honeycomb structure 28A and honeycomb structure 28B. Optionally, one or more additional intermediate facing sheets can also be provided between honeycomb structures 28A and 28B. In addition, other layers, such as one or more layers of the material of low gas permeability used for the outer shell and/or one or more reflective layers, may also optionally be provided between honeycomb structures 28A and 28B.

Although the FIG. 5 embodiment shows two stacked honeycomb structures 28A and 28B, it is also contemplated that three, or more, stacked honeycomb layers may also be provided. As with the FIG. 5 embodiment, additional layers (such as one or more facing layers, one or more low gas permeable layers, one or more reflective layers, etc.) can be provided at any, or all, of the interfaces of two honeycomb structures.

In the FIG. 5 embodiment, the cells 30A of the upper honeycomb structure 28A are of the same height, shape, and size as cells 30B of the lower honeycomb structure 30B. However, it is contemplated that any, or all three, of these parameters could be varied such that the upper honeycombs sheet 28A is of a somewhat different configuration than the lower honeycomb structure 28B. It is also contemplated that the cells (30A or 30B) within a single honeycomb structure (28A or 28B) need not all be of uniform size and/or shape within a single honeycomb structure.

Turning now to FIG. 6, modified panel 10″ is shown and will be described. Panel 10″ of FIG. 6 is essentially the same as the panel of FIG. 5, except that in panel 10″, the cells 30A of the upper honeycomb structure 28A are not aligned with the cells 30B of the lower honeycomb structure 28B, whereas in panel 10′ of FIG. 5, the upper layer of cells 30A are aligned with the lower layer of cells 30B. Thus, in panel 10″ of FIG. 6, the upper cell walls 40A are offset from the lower cell walls 40B. Such a configuration is believed to provide better rigidity than a panel such as that shown in FIG. 5. Of course, any of the modifications described above with regard to the FIG. 5 embodiment could also be applied to the FIG. 6 embodiment.

FIG. 7 shows an additional modified panel, designated as panel 10′″. The modification of FIG. 7 includes the addition of filler material 42 within each of the cells 30. One example of a type of filler material is shredded paper, such as shredded newspaper. It is believed that such filler material should improve the insulating properties of the panel 10′″. Some of the benefits of shredded paper are that it is relatively low cost and that it is lightweight. Additionally, shredded paper can be recycled, along with the other paper components, at the end of the useful life of the panel. Further, it is also contemplated that the shredded paper, as well as the other paper components in this and the other embodiments of the present panel, could be fabricated from recycled materials, instead of from fresh raw materials.

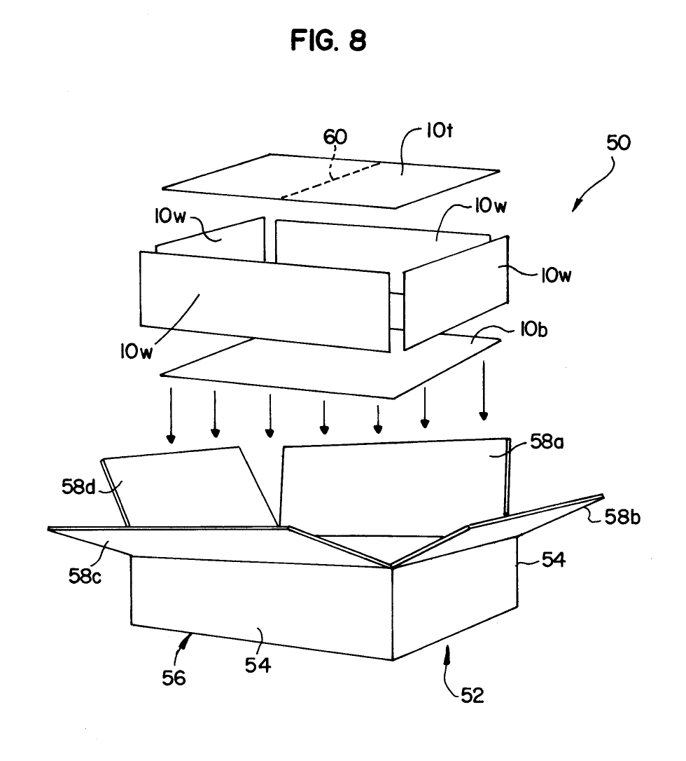

Turning now to FIG. 8, one example of an insulating packaging system 50 that includes a plurality of insulating panels 10 is shown and will be described. The system 50 of FIG. 8 includes a box 52, or other known type of packing container. The box 52 could be an ordinary cardboard box, such as corrugated cardboard or chipboard, or it could be a box specially designed for a specific purpose, such as a waterproof box, a box with extra rigidity, etc. Further, although box 52 is shown in FIG. 8 as being of a standard cuboid shape, other shapes are also contemplated, as well as other proportions for the shape shown in FIG. 8.

In the FIG. 8 example, the box 52 includes four walls 54, a base 56 and a top, where the top in this example is made of four sections 58A, 58B, 58C, and 58D. Of course single section tops or two section tops, as well as other configurations, are also contemplated as being within the scope of the invention.

An important feature of the system 50 is the inclusion of a plurality of insulating panels (10B, 10W, 10T), which are configured in the manner of any of the embodiments of the panels 10-10′″, described above. For example, FIG. 8 shows how four insulating panels 10W (where one panel 10W corresponds to each of the four walls 54 of box 52), are inserted into the box 52 and aligned with the corresponding walls 54. Panels 10W are sized to be slightly smaller than their associated wall 54, so that they can be easily inserted into the box 52, and so that there is enough room for all four panels to be appropriately positioned within the box. Preferably, the system 50 also includes a top panel 10T and a base panel 10B, which also positioned in the box 52 in the appropriate locations. However, it is contemplated that if sufficient insulation can be obtained without the top and base panels (especially in situations where multiple systems will be stacked upon each other), these panels may be omitted, thus reducing the cost and weight of the system.

In the system 50 of FIG. 8, the panels 10W, 10B and 10T may be merely placed into the box 52 and held in position by the contents of the box, and any packing materials included therein. Alternatively, any, or all, of the panels 10W, 10B and 10T could be attached to the appropriate interior surface of the box 52 with an adhesive, tape, or other desired attachment means. After the panels 10W and 10B are inserted into the box, or affixed thereto, the contents being shipped, along with any packing material and any cooling means (such as dry ice, dry ice packs, gel coolant packs, etc.), are positioned into the box. Next, the top panel 10T is placed over the contents of the box, at which point the four top sections of the box (58A, 58B, 58C, and 58D) can be closed and sealed in any known manner, such as with packing tape.

Finally, although the system 50 shown in FIG. 8 includes panels 10W, 10B and 10T that are approximately the size of their associated wall 54, base 56 or top 58, it is contemplated that the panels 10 could be sized to cover only a portion of their associated wall, base or top, such that two or more panels would be used to cover each portion of the box 52 with a single layer of panels. For example, top panel 10T could be produced in half of its size shown in FIG. 8 (as if it were divided along dashed line 60), in which case it would require two panels for the top portion. Such a configuration could be used for the walls or base also, and could reduce the number of differently sized panels required for each system if the box 54 included certain redundant dimensions (such as if the side panels of the box were half the size of the base and top panels box).

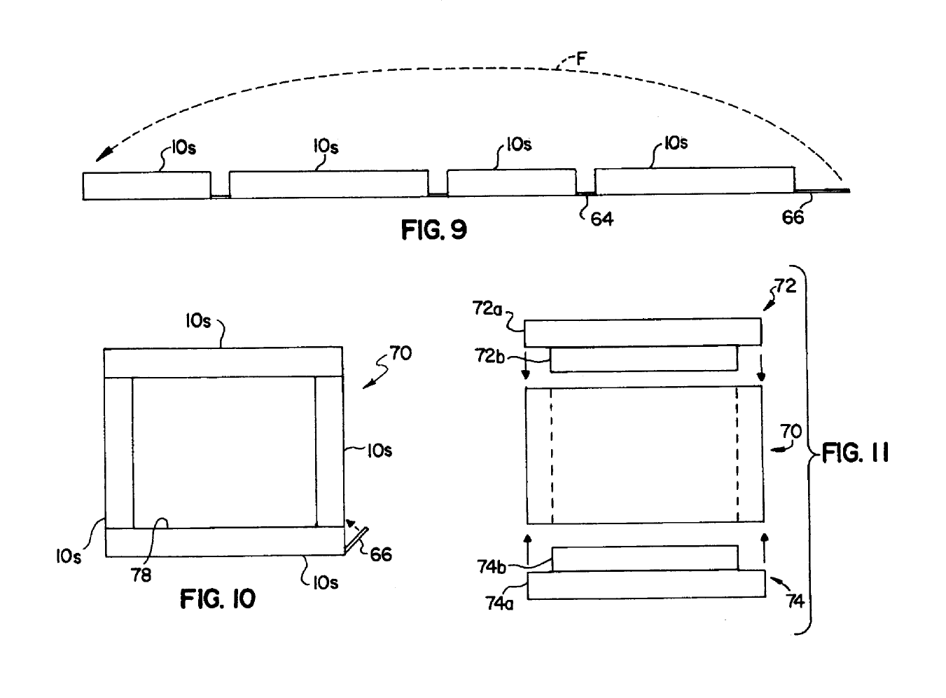

Turning now to FIGS. 9-11, another example of an insulating packaging system is shown, which system could be placed within a box, such as box 52 of FIG. 8. FIG. 9 shows a plurality of side panels 10S, which are spaced apart from each other and attached to a sheet 64. Side panels 10S are insulating panels that are configured in the manner of any of the embodiments of the panels 10-10′″, as described above. Sheet 64 may be made of any of a variety of different materials, such as thick, flexible paper or polyethylene plastic, for example. One end of the sheet 64 preferably includes a tab 66. Preferably the tab 66 includes a self-adhesive feature (such as a tear-off strip which, upon removal, reveals an adhesive layer on the tab), which can be used to make a rectangular tube configuration, such as shown in top view in FIG. 10, by folding the sheet over itself, such as along dashed arrow F of FIG. 9, and then “popping” the structure open to resemble the configuration of FIG. 10, which is a top view of the open structure. Once the structure has been opened, the tab 66 can be affixed to the side of the relevant panel 10S, such as by using the tear-off strip, or by using other desired adhesive means. Once the tab has been affixed, the structure of the four panels 10S should be able to maintain the open-top and open-bottom box-like shape 70 shown in FIG. 10.

Turning now to FIG. 11, the open box-like structure 70 of FIG. 10 is shown in side view. FIG. 11 also shows a top assembly 72 and a bottom assembly 74. The top assembly 72 is preferably made of two panels 72A and 72B that are attached to each other by any desired method. Similarly, the bottom assembly 74 is also preferably made of two panels 74A and 74B that are attached to each other by any desired method. Panels 72A, 72B, 74A and 74B are insulating panels that are configured in the manner of any of the embodiments of the panels 10-10′″, as described above. As can be seen in the FIG. 11 embodiment, inner panels 72B and 74B are smaller than associated outer panels 72A and 72B, respectively. This configuration enables the top and bottom assemblies 72 and 74 to snugly fit within the opening 78 (FIG. 10) formed within structure 70, such that a closed container is formed. The three components of the closed container (70, 72 and 74) can be attached together in any desired manner, such as with packing tape.

Although such a closed container could conceivably used for shipping once it was sealed together, it is preferable to place the closed container within another box, such as box 52 of FIG. 8. This is the case because an outer box, such a box 52, will help to protect the structure 70, the top assembly 72 and the bottom assembly 74 from being damaged while being used for shipment of goods. Protection from damage is important because certain types of damage, such as situations in which the outer shell 22 (FIGS. 3-7) is ruptured, can cause a loss of the vacuum level, resulting in diminished insulation qualities.

While particular embodiments of insulating panels and systems including such panels have been shown and described, it will be appreciated by those skilled in the art that changes and modifications may be made thereto without departing from the invention in its broader aspects and as set forth in the following claims.

What is claimed is:

1. An insulating panel comprising:
a paper core that comprises at least one panel consisting of first and second facing sheets, made of paper, that sandwich a paper honeycomb structure, wherein said honeycomb structure includes a plurality of cells that extend from said first facing sheet to said second facing sheet; and
an outer shell that surrounds said core, wherein said outer shell is made of a material of low gas permeability and is sealed to form a substantially airtight container around said core,
wherein said first facing sheet includes a plurality of evacuation apertures configured and arranged such that at least one of said evacuation apertures is in fluid communication with each of said cells of said honeycomb structure whereby evacuation of air from said cells is facilitated,
wherein an interior of said outer shell has been evacuated to a pressure less than approximately 10 Torr.

2. The insulating panel according to claim 1, further comprising a reflective layer positioned on an outer surface of at least one of said first and second facing sheets.

3. The insulating panel according to claim 1, further comprising:
a first reflective layer positioned on an outer surface of said first facing sheet; and
a second reflective layer positioned on an outer surface of said second facing sheet,
wherein said first and second reflective layers each comprise a metal foil sheet or a metalized sheet, and
further wherein said first reflective sheet includes a plurality of apertures in positions that correspond to positions of said plurality of evacuation apertures in said first facing sheet.

4. The insulating panel according to claim 1, wherein said paper core is relatively rigid.

5. The insulating panel according to claim 1, further comprising shredded paper filler material within each of said cells.

6. The insulating panel according to claim 1, wherein at least said first and second facing sheets and said honeycomb structure are comprised of recyclable materials.

7. The insulating panel according to claim 1, wherein, after completion of manufacturing of said insulating panel, a desired level of vacuum is substantially maintained within said paper core of said insulating panel by said outer shell, without the use of a vacuum pump.

8. The insulating panel according to claim 1, wherein each of said cells has an interior volume within the range of approximately 0.325 to 2.6 cubic inches.

9. The insulating panel according to claim 1, wherein each of said cells is generally hexagon shaped, when considered in plan view.

10. The insulating panel according to claim 1, further comprising:
a second paper core that comprises at least one second panel consisting of two facing sheets, made of paper, that sandwich a second paper honeycomb structure, wherein said second honeycomb structure includes a plurality of second cells, and
wherein said second paper core is stacked upon said paper core.

11. An insulating panel comprising:
a paper core that comprises at least one panel consisting of first and second facing sheets, made of paper, that sandwich a paper honeycomb structure, wherein said honeycomb structure includes a plurality of cells that extend from said first facing sheet to said second facing sheet; and
an outer shell that surrounds said core, wherein said outer shell is made of a material of low gas permeability and is sealed to form a substantially airtight container around said core,
wherein an interior of said outer shell has been evacuated to a pressure of between approximately 1-10 Torr.

12. The insulating panel according to claim 11, wherein said insulating panel has an R-value of approximately 3.

13. The insulating panel according to claim 11, wherein said material of lower gas permeability of said outer shell comprises a material selected from one of the following: ethylene vinyl alcohol (EVOH); polyvinyllidene chloride (PVDC); a ceramic barrier film; barrier grade nylon; an aluminum foil or a metalized film.

14. The insulating panel according to claim 11, wherein at least said first and second facing sheets and said honeycomb structure are comprised of recyclable materials.

15. An insulating packaging system comprising;
a box with a plurality of walls, a base and a top; and
a plurality of insulating panels, with one of said insulating panels corresponding to each of said walls,
wherein each of said insulating panels comprises:
a core that comprises at least one panel consisting of first and second facing sheets that sandwich a honeycomb structure, wherein said honeycomb structure includes a plurality of cells that extend from said first facing sheet to said second facing sheet; and
an outer shell that surrounds said core, wherein said outer shell is made of a material of low gas permeability and is sealed to form a substantially airtight container around said core, and
wherein a vacuum is established within an interior of said outer shell.

16. The insulating packaging system according to claim 15, further comprising:
a top insulating panel that corresponds to said top of said box; and
a base insulating panel that corresponds to said base of said box.

17. The insulating packaging system according to claim 15, wherein, after completion of manufacturing of said insulating panel, a vacuum state is substantially maintained within said paper core of said insulating panel by said outer shell, without the use of a vacuum pump.

18. The insulating packaging system according to claim 15, wherein each of said insulating panels is attached to one of said walls of said box via an adhesive.

19. The insulating packaging system according to claim 15, wherein said first facing sheet includes a plurality of evacuation apertures configured and arranged such that at least one of said evacuation apertures is in fluid communication with each of said cells of said honeycomb structure, whereby evacuation of air from said cells is facilitated.

20. The insulating packaging system according to claim 15, wherein said insulating panels corresponding to each of said walls are spaced apart from each other and attached to each other via a sheet.
